(19) United States
(12) Patent Application Publication
(10) Pub. No.: US 2019/0172164 A1
(43) Pub. Date: Jun. 6, 2019

(54) METHOD AND SYSTEM FOR ENVIRONMENTAL ANALYSIS

(71) Applicant: William E. Hayward, Monterey, CA (US)

(72) Inventor: Nathan C. Bellino, Orangevale, CA (US)

(21) Appl. No.: 16/208,460

(22) Filed: Dec. 3, 2018

Related U.S. Application Data
(60) Provisional application No. 62/593,511, filed on Dec. 1, 2017.

(51) Int. Cl. G06Q 50/16

(52) U.S. Cl. CPC G06Q 50/163; G06F 3/0484

(57) ABSTRACT

One embodiment provides a system comprising a data store maintaining an electronic record comprising a profile for a property area and environmental conditions for property area. The system further comprises a recommendation engine configured to access the electronic record in the data store, automatically generate one or more recommendations to improve an environment of the property area based on a set of rules, the profile for the property area, and the environmental conditions for the property area, and provide the one or more recommendations to a client device for display in an interactive graphical user interface on the client device.

### CROSS REFERENCE TO RELATED APPLICATIONS

The present application claims priority to U.S. Provisional Patent Application No. 62/593,511, filed on Dec. 1, 2017, hereby incorporated by reference in its entirety.

### TECHNICAL FIELD

One or more embodiments relate generally to environmental analysis, and in particular, a method and system for recommending recommendations for improving an environment of a property.

### BACKGROUND

Conventionally, a property is physically inspected to determine the structural integrity of the property. A property owner may retain the services of a qualified property inspector to physically inspect the property and assess potential health-related issues that may arise as a result of occupying the property. The assessment provided by the property inspector, however, may be biased, limited due to lack of sufficient data, and susceptible to human error. Further, retaining the services of the property inspector may be costly.

### SUMMARY

One embodiment provides a system comprising a data store maintaining an electronic record comprising a profile for a property area and environmental conditions for property area. The system further comprises a recommendation engine configured to access the electronic record in the data store, automatically generate one or more recommendations to improve an environment of the property area based on a set of rules, the profile for the property area, and the environmental conditions for the property area, and provide the one or more recommendations to a client device for display in an interactive graphical user interface on the client device.

These and other features, aspects and advantages of the one or more embodiments will become understood with reference to the following description, appended claims and accompanying figures.

### BRIEF DESCRIPTION OF THE DRAWINGS

FIG. 1 illustrates an example computing architecture for implementing an environmental analysis system, in one or more embodiments;

FIG. 2 illustrates an example recommendation engine, in one or more embodiments;

FIG. 3A illustrates an example process implemented by the recommendation engine and involving a first set of rules, in one or more embodiments;

FIG. 3B illustrates specific recommendations generated by the recommendation engine as part of the example process in FIG. 3A, in one or more embodiments;

FIG. 4A illustrates an example process implemented by the recommendation engine and involving a second set of rules, in one or more embodiments;

FIG. 4B illustrates specific recommendations generated by the recommendation engine as part of the example process in FIG. 4A, in one or more embodiments;

FIG. 5A illustrates an example process implemented by the recommendation engine and involving a third set of rules, in one or more embodiments;

FIG. 5B illustrates specific recommendations generated by the recommendation engine as part of the example process in FIG. 5A, in one or more embodiments;

FIG. 6A illustrates an example process implemented by the recommendation engine and involving a fourth set of rules, in one or more embodiments;

FIG. 6B illustrates specific recommendations generated by the recommendation engine as part of the example process in FIG. 6A, in one or more embodiments;

FIG. 7A illustrates an example process implemented by the recommendation engine and involving a fifth set of rules, in one or more embodiments;

FIG. 7B illustrates specific recommendations generated by the recommendation engine as part of the example process in FIG. 7A, in one or more embodiments;

FIG. 8 illustrates a first set of example graphical user interfaces (GUIs) generated by the recommendation engine for display on a client device, in one or more embodiments;

FIG. 9 illustrates a second set of example GUIs generated by the recommendation engine for display on a client device, in one or more embodiments;

FIG. 10 illustrates a third set of example GUIs generated by the recommendation engine for display on a client device, in one or more embodiments;

FIG. 11 is a flowchart of an example process for generating a recommendation, in one or more embodiments;

FIG. 12 is a flowchart of another example process for generating a recommendation, in one or more embodiments; and

FIG. 13 is an exemplary high-level block diagram showing an information processing system comprising a computer system useful for implementing disclosed embodiments.

### DETAILED DESCRIPTION

The following description is made for the purpose of illustrating the general principles of one or more embodiments and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

One or more embodiments relate generally to environmental analysis, and in particular, a method and system for recommending recommendations for improving an environment of a property. One embodiment provides a system comprising a data store maintaining an electronic record comprising a profile for a property area and environmental conditions for property area. The system further comprises a recommendation engine configured to access the electronic record in the data store, automatically generate one or more recommendations to improve an environment of the property area based on a set of rules, the profile for the property area, and the environmental conditions for the property area, and provide the one or more recommendations to a client device for display in an interactive graphical user interface on the client device.

In this specification, the terms “property” and “property area” are generally used to reference all synonyms of different types of spaces, areas and dwellings intended for occupancy, whether commercial or residential, single or multi-family, individual structures or tract developments governed by homeowners association (HOA) covenance, currently existing, under construction or proposed. Examples of properties/property areas may include, but are not limited to, the following: a house, a dwelling, a mobile home, a set of houses, a housing development, a suburb, a town, a city, a state, a country, an apartment building composed of multiple units, an estate, housing stock, a set of houses within an enclosed geographic area, a set of houses that are separated by significant space, a city block, a building, a property approved for inhabitation, a set of houses that share a common characteristic, such as a peaked roof, a site of a future house, sites of future houses, a construction site for a house or multiple houses, track houses, custom homes, all houses within a given region, a houseboat, a physical space that currently contains one or more houses, covenance controlled groupings or developments (e.g., groupings or developments governed by HOA covenance), and housing stock owned, controlled and/or managed by a government, a property management group, a developer or a builder. The terms “property” and “property area” are used interchangeably in this specification.

In this specification, the term “user” is generally used to reference an individual or an entity. Examples of users include, but are not limited to, the following: may be a current owner of a property, a prospective owner of a property, an occupant of a property (e.g., a tenant), an individual who is present on a property for work/educational purposes (e.g., an employee of a business operating on a property, a student of a school operating on a property), a patron of a business operating on a property (e.g., a hotel guest, a restaurant guest), etc. The terms “individual” and “user” are used interchangeably in this specification.

In this specification, the term “pollutants” is generally used to reference materials that may negatively impact/harm an environment and health of an individual. Pollutants may originate in an indoor environment or an outdoor environment. There may be different types of pollutants, such as chemical pollutants, biological pollutants, and toxic pollutants. Examples of different chemical pollutants, biological pollutants and toxic pollutants may include, but are not limited to, the following: pathogens (e.g., infectious agents such as bacteria, virus, fungi, etc.), irritants (e.g., chemicals that are not corrosive to human tissue and whose effects are reversible), poison (e.g., substances with an inherent property that may destroy human life or impair human health), toxin (e.g., a poison produced by an organism), allergens, gases, chemicals, pollen, jet fuel, freeway emissions, dust mites, dust mite by products, dampness, molds, mycotoxins, chemicals, bacteria, yeast, micro biome imbalances, excess particulate, ozone imbalances, Volatile Organic Compounds, Microbial Volatile Organic Compounds, Semi-volatile Organic Compounds, lead paint, asbestos, microfibers, etc.

Environmental conditions of a property area, such as a house, impacts individual health of occupants of the property area. Embodiments of the invention provide systems and methods for environmental analysis. One or more embodiments of the invention provide systems and methods for monitoring environmental conditions of property areas and providing expert guidance in creating a non-toxic, unpolluted, and healthy environments at the property areas. In one embodiment, data elements received via source inputs and indicative of environmental conditions of the property areas are processed to monitor and provide actionable recommendations to property owners or occupants of the property areas.

Embodiments of the invention provide significant technical improvements to facilitate property environmental monitoring and decisioning processes. Embodiments of the invention are directed to more than merely a computer implementation of a routine or conventional activity previously known in the industry as it significantly advances the technical efficiency, access and/or accuracy of communications between devices by implementing a specific new method and system as defined herein.

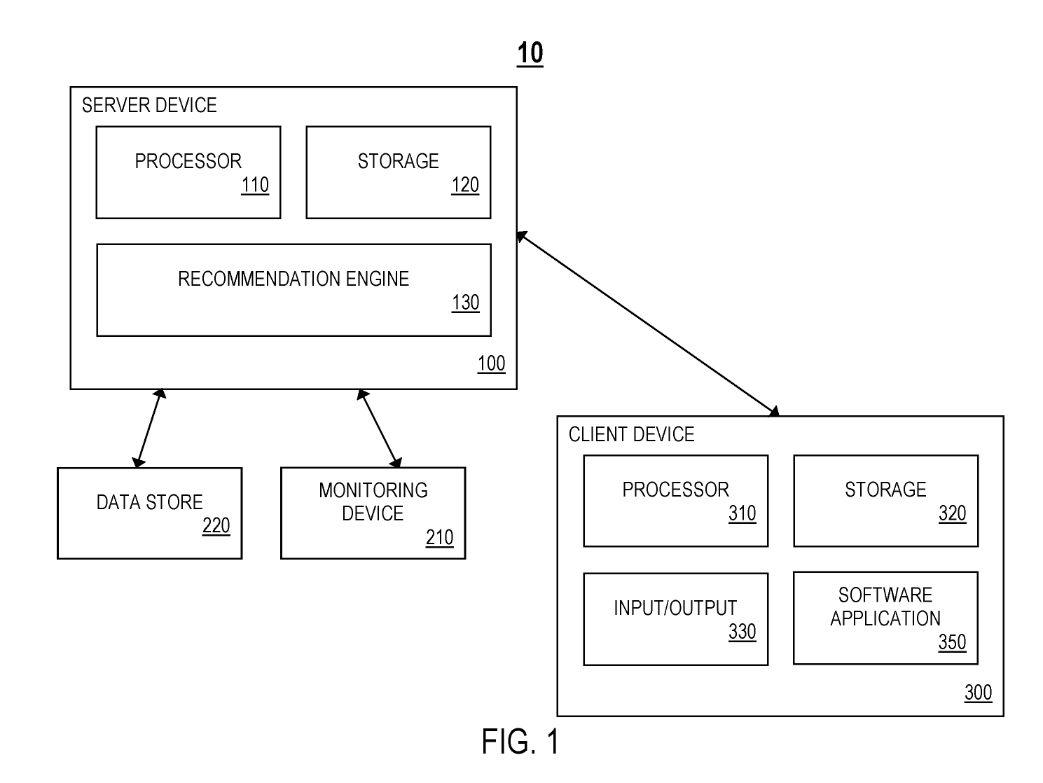

FIG. 1 illustrates an example computing architecture 10 for implementing an environmental analysis system, in one or more embodiments. The computing architecture 10 comprises a server device 100 including computation resources, such as one or more processors 110 and one or more storage units 120. One or more applications may execute/operate on the server device 100 utilizing the computation resources of the server device 100. In one embodiment, the server device 100 comprises a back-end application computer server. In one embodiment, the back-end application computer server can be associated with a Personal Computer (“PC”), a laptop computer, a smartphone, an enterprise server, a server farm, and/or a database or a similar storage device. According to some embodiments, an “automated” back-end application computer server can facilitate the evaluation of information about a property area in order to provide recommendations or other information about environmental conditions associated with the property area. As used herein, the term “automated” may refer to, for example, actions that can be performed with little (or no) intervention by a human.

In one embodiment, the one or more applications on the server device 100 include, but are not limited to, a recommendation engine 130 implementing an environmental analysis system. The recommendation engine 130 is configured to: (1) receive input data indicative of environmental conditions of a property area, and (2) generate recommendations for improving an environment of the property area (e.g., creating a non-toxic, unpolluted, and healthy environment) based on the input data received.

In one embodiment, the server device 100 is configured to exchange data with one or more remote devices over a connection (e.g., a wireless connection such as a WiFi connection or a cellular data connection, a wired connection, or a combination of the two). Examples of remote devices include, but are not limited to, a client device 300, a monitoring device 210, a data store 220, etc. As used herein, devices, including those associated with the server device 100 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Any devices described herein may communicate via one or more such communication networks.

In one embodiment, the recommendation engine 130 is configured to receive input data from any one of the remote devices referenced above.

Examples of a remote client device 300 include, but are not limited to, a mobile electronic device such as a tablet, a smart phone, a laptop, etc. As described in detail later herein, the recommendation engine 130 is configure to receive input data from a remote client device 160 and/or send recommendations to the client device 160 for display to a user operating the client device 160, wherein the recommendations allow the user to monitor, modify, and remediate an environment of the property area.

Examples of a monitoring device 210 include, but are not limited, a monitoring/sensor device for monitoring and collecting data related to one or more environmental conditions of a property area (“monitoring data”). In one embodiment, monitoring data comprises data indicative of presence of toxins and pollutants that impact individual health (i.e., toxin and pollutant trends). For example, in one embodiment, monitoring data includes readings relating to at least one of the following: (1) atmospheric particulate matter (PM), such as PM2.5 readings for PM that have a diameters less than 2.5 micrometers, (2) Volatile Organic Compounds (VOCs) (e.g., acetone, gasoline, etc.), and/or (3) humidity. In one embodiment, a monitoring device 210 is connected in a network (e.g., such as via a wi-fi network in a property area). In one embodiment, monitoring data is collected on a periodic basis (e.g., such as every five minutes).

In one embodiment, a single monitoring device 210 is deployed at a property area to collect a plurality of data points related to environmental conditions of the property area. In another embodiment, multiple monitoring devices 210 are distributed throughout a property area to provide an accurate reading of environmental conditions within the property area.

In one embodiment, the server device 100 accesses information stored in a data store 220. The server device 100 is configured to store information into and/or retrieve information from the data store 220. For example, in one embodiment, the data store 220 maintains one or more electronic records associated with one or more property areas such as, but not limited to, one or more home profiles (i.e., building profiles) for the one or more property areas, historical information comprising environmental conditions of the one or more property areas (e.g., historical monitoring data collected by one or more monitoring devices 210 and/or historical third party data from one or more third party data sources, such as historical weather patterns, historical trends of outdoor pollutants), current environmental conditions of the one or more property areas (e.g., current monitoring data collected by one or more monitoring devices 210 and/or current third party data from one or more third party data sources, such as current weather conditions, current outdoor pollutants), etc. A home profile comprises home profile data for a property area, wherein the home profile comprises one or more user responses to one or more questions included in a home profile questionnaire. As described in detail later herein, a home profile questionnaire comprises one or more questions related to a property area.

In one embodiment, a client device 300 comprises computation resources, such as one or more processors 310 and one or more storage units 320. One or more applications may execute/operate on the client device 300 utilizing the computation resources of the client device 300 such as a software application 350 for accessing the environmental analysis system provided by the recommendation engine 130. In one embodiment, a software application 350 may be pre-loaded onto or downloaded to the client device 300. An application 350 may originate from a device vendor (e.g., an original equipment manufacturer (OEM)) of the client device 300 (i.e., a vendor application) or originate from a third party (e.g., a community, a user, a partner). Examples of a software application 350 include, but are not limited to, a web browser, a mobile application (“mobile app”), etc.

In one embodiment, a client device 300 comprises one or more one or more input/output (I/O) units 330 integrated in or coupled to the client device 300, such as a keyboard, a keypad, a touch interface, or a display screen. In one embodiment, data associated with a user profile (e.g., a user profile of a homeowner having an account with the system 100) may be updated or modified by a user. For example, a user may provide user responses to questions included in a home profile questionnaire over multiple sessions and may also view or edit the user responses via one or more client devices 300.

In one embodiment, one or more recommendations generated by the recommendation engine 130 are presented for display on a client device 300. In one embodiment, a recommendation comprises, but is not limited, to at least one of the following: (1) a recommended action item/task for a user to perform with respect to an existing piece of equipment at a property area (e.g., turning on a stove fan to vent air), (2) a recommended product, such as a recommended installation of a new piece of equipment at the property area (e.g., installing hardwood floors) or a recommended modification of an existing piece of equipment at the property area (e.g., replacing a stove fan), and/or (3) a recommended service to perform (e.g., a mold test). In one embodiment, if the recommendation engine 130 determines that an installation or a modification of an equipment at the property area is required, the recommendation engine 130 is configured to generate a specific recommendation including specific details relating to the installation or modification, such as where the equipment should be located, properties of the equipment (e.g., size, fan velocity, etc.), service providers that can provide contractors/installers to perform the installation or modification, etc.

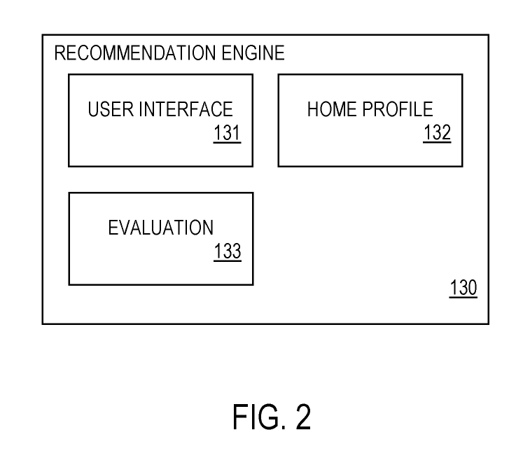

FIG. 2 illustrates an example recommendation engine 130, in one or more embodiments. In one embodiment, the recommendation engine 130 comprises a user interface system 131 configured to generate one or more interactive graphical user interfaces (GUIs) for display on a client device 300. For example, the user interface system 131 is configured to generate one or more GUIs including a home profile questionnaire, wherein a user can interact with the GUIs to provide user responses to questions included in the questionnaire.

As another example, the user interface system 131 is configured to generate one or more GUIs including one or more recommendations for improving an environment of a property area, wherein a user can interact with the GUIs to view the one or recommendations, purchase one or more recommended services or products, etc.

In one embodiment, the recommendation engine 130 comprises a home profile system 132 configured to generate a home profile including home profile data for a property area based on user responses to questions included in a home profile questionnaire. The home profile system 132 is configured to maintain the home profile in a storage device (e.g., the data store 220).

In one embodiment, the recommendation engine 130 comprises an evaluation system 133 configured to analyze/evaluate monitoring data, home profile data, and/or third party data for a property area, and generate one or more recommendations for improving an environment of the property area based on the analysis/evaluation. In one embodiment, the analysis/evaluation comprises determining a set of rules to apply based on environmental conditions of the property area (as determined based on the monitoring data and/or the third party data), and applying the set of rules to the home profile data. In one embodiment, the analysis/evaluation comprises making one or more comparisons based on one or more pre-determined thresholds (e.g., pre-determined thresholds for levels of toxins and pollutants, etc.). In another embodiment, the analysis/evaluation comprises applying a trained/learned predictive model (e.g., trained using standard machine learning algorithms) to the home profile data, the monitoring data and/or the third party data.

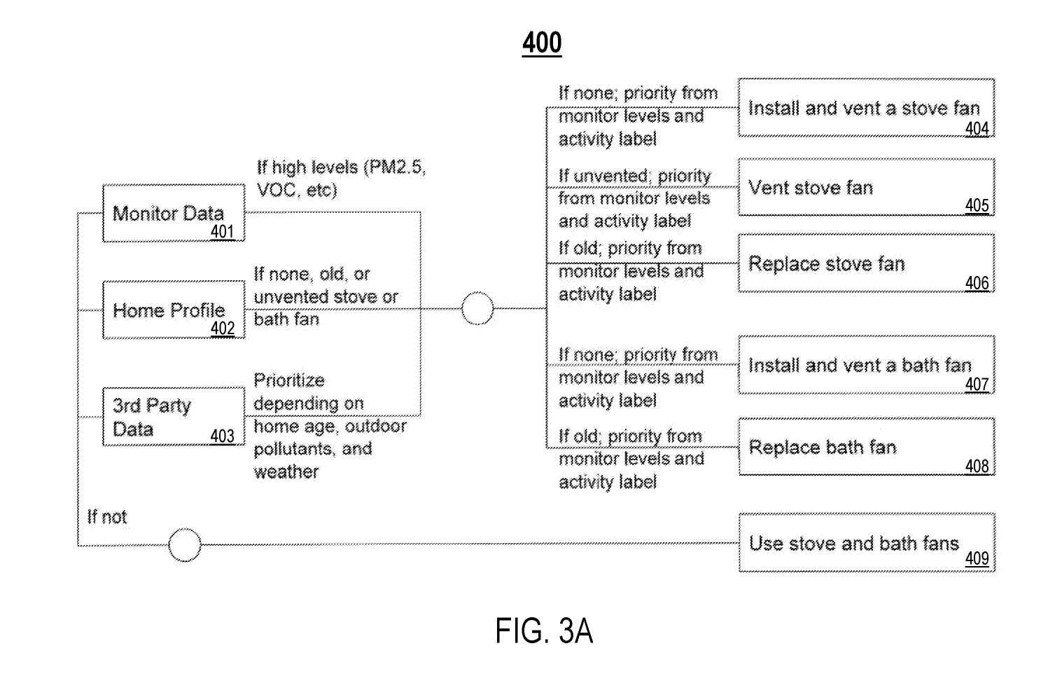

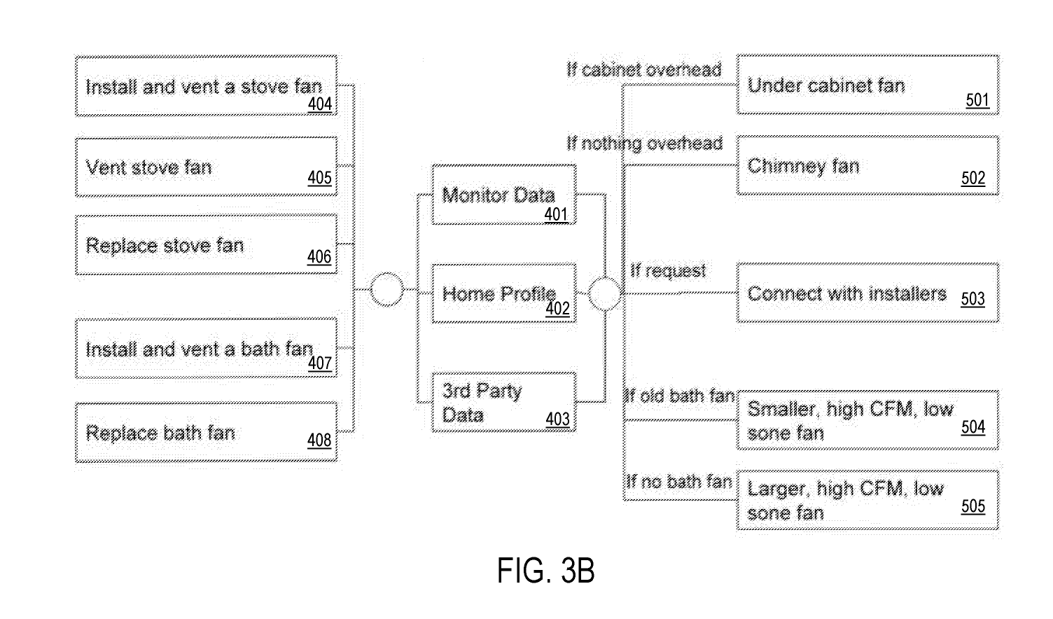

FIG. 3A illustrates an example process 400 implemented by the recommendation engine 130 and involving a first set of rules, in one or more embodiments. In one embodiment, the recommendation engine 130 is configured to receive at least one of the following: (1) monitoring data 401 (e.g., from a monitoring device 210) comprising one or more readings indicative of levels of toxins and pollutants at a property area (e.g., PM, VOCs, etc.), (2) home profile data 402 (e.g., from the data store 220) comprising information relating to a stove fan at the property area, and/or a bathroom fan at the property area, and (3) third party data 403 (e.g., from the data store 220). In one embodiment, the recommendation engine 130 is configured to prioritize the third party data 403 based on age of the property area, outdoor pollutants, and/or weather.

If the monitoring data 401 indicates high levels of toxins and pollutants at the property area (e.g., high levels of PM2.5, VOCs, etc.), the recommendation engine 130 is configured to generate a recommendation based on the home profile data 402 and/or the third party data 403.

For example, if the recommendation engine 130 determines that the property area does not have a stove fan, the recommendation engine 130 generates a recommendation 404 to install and vent a stove fan at the property area. As another example, if the recommendation engine 130 determines that the property area has an unvented stove fan, the recommendation engine 130 generates a recommendation 405 to vent the stove fan. As yet another example, if the recommendation engine 130 determines that the property area has an old stove fan, the recommendation engine 130 generates a recommendation 406 to replace the stove fan.

For example, if the recommendation engine 130 determines that the property area does not have a bathroom fan, the recommendation engine 130 generates a recommendation 407 to install and vent a bathroom fan at the property area. As another example, if the recommendation engine 130 determines that the property area has an old bathroom fan, the recommendation engine 130 generates a recommendation 408 to replace the bathroom fan.

As described in detail later herein, in one embodiment, the recommendation engine 130 determines a type of fan to install or replace with based on levels of toxins and pollutants at the property area (as determined from the monitoring data 401) and/or activity label (e.g., purpose of the fan, such as in the kitchen or in the bathroom).

If the monitoring data 401 indicates low or moderate levels of toxins and pollutants at the property area (e.g., low or moderate levels of PM2.5, VOCs, etc.), the recommendation engine 130 generates a recommendation 409 to use an existing stove fan and/or an existing bathroom fan at the property area.

FIG. 3B illustrates specific recommendations generated by the recommendation engine 130 as part of the example process 400 in FIG. 3A, in one or more embodiments. Based on the monitoring data 401, the home profile data 402, and/or the third party data 403, the recommendation engine 130 is configured to generate recommendations with specific details.

In one embodiment, with respect to the recommendations 404, 405, and/or 406, the recommendation engine 130 may include information indicative of a type of stove fan to install or replace with and/or where the stove fan should be located. For example, if the recommendation engine 130 determines that the property area has a cabinet above (i.e., overhead) a stove, the recommendation engine 130 generates a specific recommendation 501 that the stove fan to install or replace with should be an under cabinet fan (i.e., located under the cabinet). If the recommendation engine 130 determines that the property area does not have a cabinet above a stove, the recommendation engine 130 generates a specific recommendation 502 that the stove fan to install or replace with should be a chimney fan.

In one embodiment, with respect to the recommendations 407 and/or 408, the recommendation engine 130 may include information indicative of properties of a bathroom fan to install or replace with. For example, if the recommendation engine 130 determines that the property area has an old bathroom fan, the recommendation engine 130 generates a specific recommendation 504 that the bathroom fan to replace with should be a small bathroom fan with a high cubic feet per minute (CFM) and a low sone rating. As another example, if the recommendation engine 130 determines that the property area does not have a bathroom fan, the recommendation engine 130 generates a specific recommendation 505 that the bathroom fan to install should be a large bathroom fan with a high CFM and a low sone rating.

In one embodiment, the recommendation engine 130 receives a request from a user to connect with service providers that can provide contractors/installers to perform a recommended installation or modification of a fan (e.g., a bathroom fan or a stove fan). In response to receiving the request from the user, the recommendation engine 130 provides one or more online tools 503 that allow the user to view one or more available service providers, schedule a service appointment for the installation or modification with an available service provider, obtain quotes for the installation or modification from an available service provider, pre-pay for the installation or modification, etc.

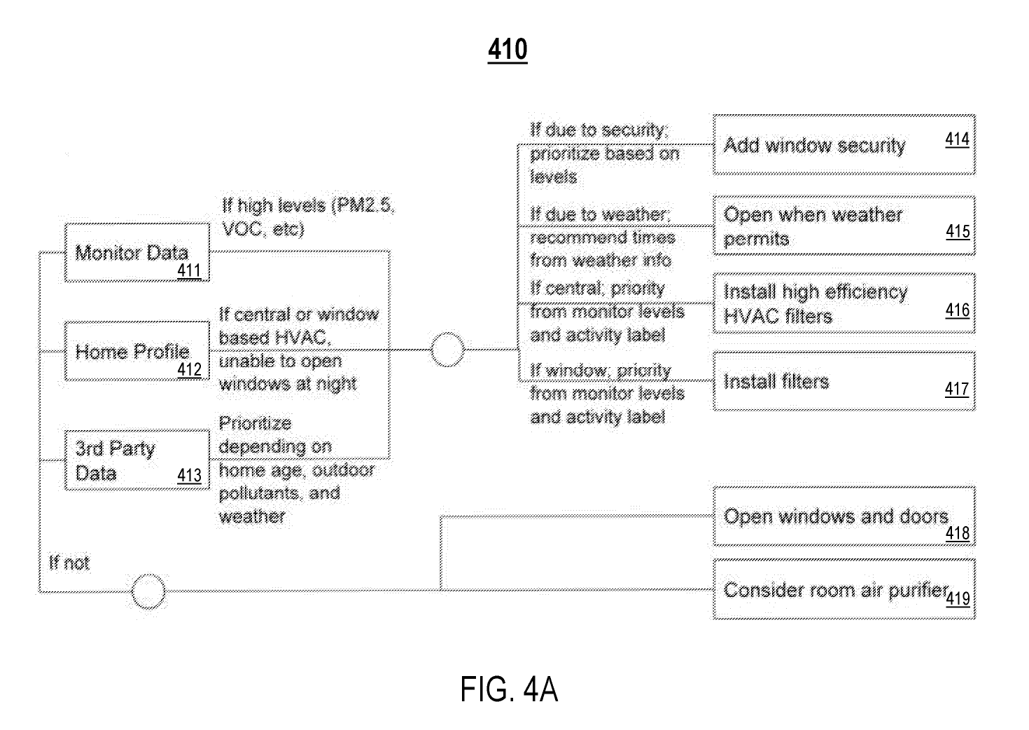

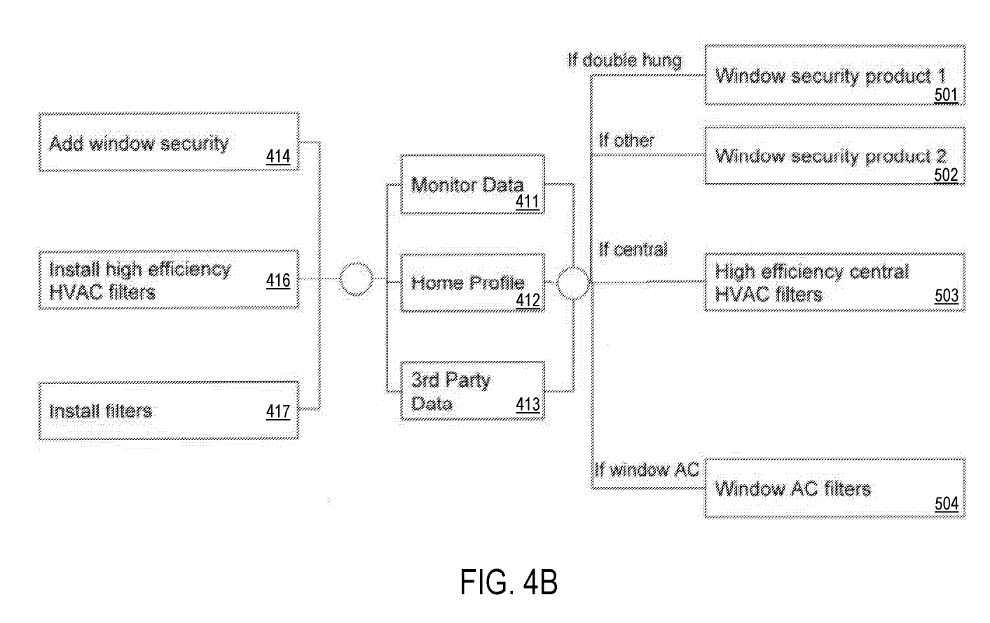

FIG. 4A illustrates an example process 410 implemented by the recommendation engine 130 involving a second set of rules, in one or more embodiments. In one embodiment, the recommendation engine 130 is configured to receive at least one of the following: (1) monitoring data 411 (e.g., from a monitoring device 210) comprising one or more readings indicative of levels of toxins and pollutants at a property area (e.g., PM, VOCs, etc.), (2) home profile data 412 (e.g., from the data store 220) comprising information relating to a heating, ventilation, and air conditioning (HVAC) system at the property area, and (3) third party data 413 (e.g., from the data store 220). In one embodiment, the recommendation engine 130 is configured to prioritize the third party data 413 based on age of the property area, outdoor pollutants, and/or weather.

If the monitoring data 411 indicates high levels of toxins and pollutants at the property area (e.g., high levels of PM2.5, VOCs, etc.), the recommendation engine 130 is configured to generate a recommendation based on the home profile data 412 and/or the third party data 413.

For example, if the recommendation engine 130 determines that the property area has windows that cannot be opened at night due to security reasons, the recommendation engine 130 generates a recommendation 414 to add a security system to the windows so that the windows can be opened at night (e.g., to improve airflow at the property area). As another example, if the recommendation engine 130 determines that the property area has windows that cannot be opened at night due to weather conditions (e.g., inclement weather), the recommendation engine 130 determines times when the windows can be opened based on weather information for the property area, and generates a recommendation 415 to open the windows at the times determined (e.g., to improve airflow at the property area).

For example, if the recommendation engine 130 determines that the property area has a central HVAC system, the recommendation engine 130 generates a recommendation 416 to install high efficiency HVAC filters. As another example, if the recommendation engine 130 determines that the property area has a window-based HVAC system, the recommendation engine 130 generates a recommendation 417 to install filters.

As described in detail later herein, in one embodiment, the recommendation engine 130 determines a type of window security and/or filter to add or install based on levels of toxins and pollutants at the property area (as determined from the monitoring data 411) and/or activity label (e.g., purpose of the fan, such as in the kitchen or in the bathroom).

If the monitoring data 401 indicates low or moderate levels of toxins and pollutants at the property area (e.g., low or moderate levels of PM2.5, VOCs, etc.), the recommendation engine 130 generates a recommendation 418 to open windows and doors (e.g., to improve airflow at the property area) and/or a recommendation 419 to consider adding a room air purifier.

FIG. 4B illustrates specific recommendations generated by the recommendation engine 130 as part of the example process 410 in FIG. 4A, in one or more embodiments. Based on the monitoring data 411, the home profile data 412, and/or the third party data 413, the recommendation engine 130 is configured to generate recommendations with specific details.

In one embodiment, with respect to the recommendation 414, the recommendation engine 130 may include information indicative of a type of window security system to add (e.g., that is suitable for windows at the property area). For example, if the recommendation engine 130 determines that the property area has windows that are double hung, the recommendation engine 130 generates a specific recommendation 501 that the window security system to add should be a first window security product. As yet another example, if the recommendation engine 130 determines that the property area has windows that are of a different type instead, the recommendation engine 130 generates a specific recommendation 502 that the window security system to add should be a second window security product.

In one embodiments, with respect to the recommendations 416 and/or 417, the recommendation engine 130 may include information indicative of a type of filter to install (e.g., that is suitable for a HVAC system at the property area). For example, if the recommendation engine 130 determines that the property area has a central HVAC system, the recommendation engine 130 generates a specific recommendation 503 to install high efficiency, central HVAC filters. As yet another example, if the recommendation engine 130 determines that the property area has a window-based HVAC system, the recommendation engine 130 generates a specific recommendation 504 to install window AC filters.

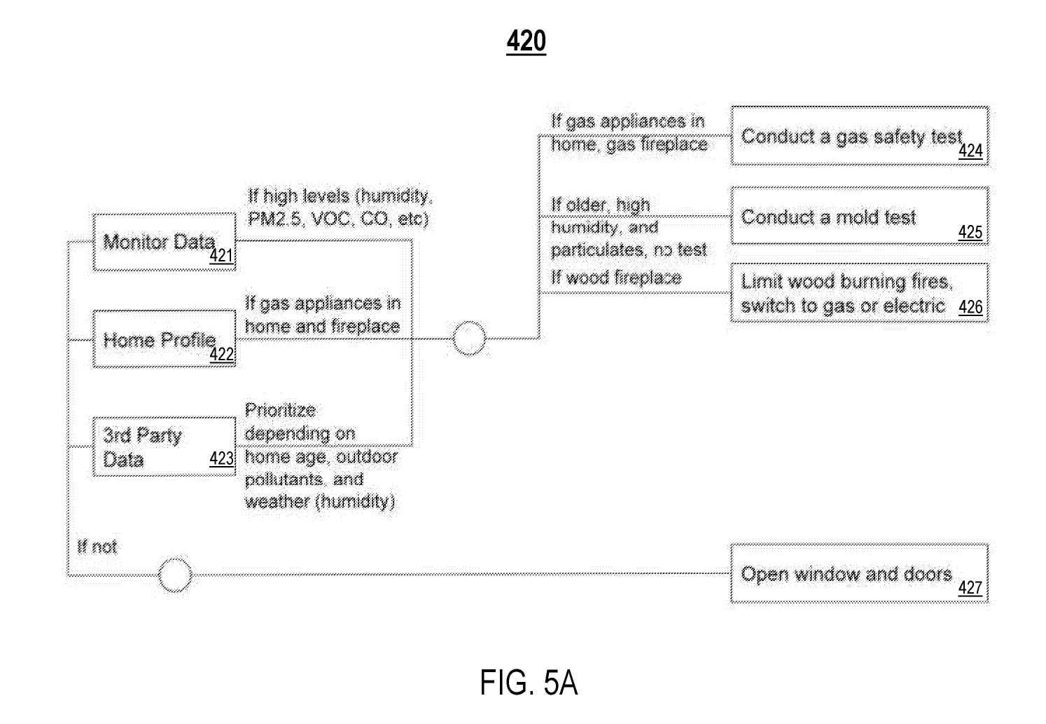

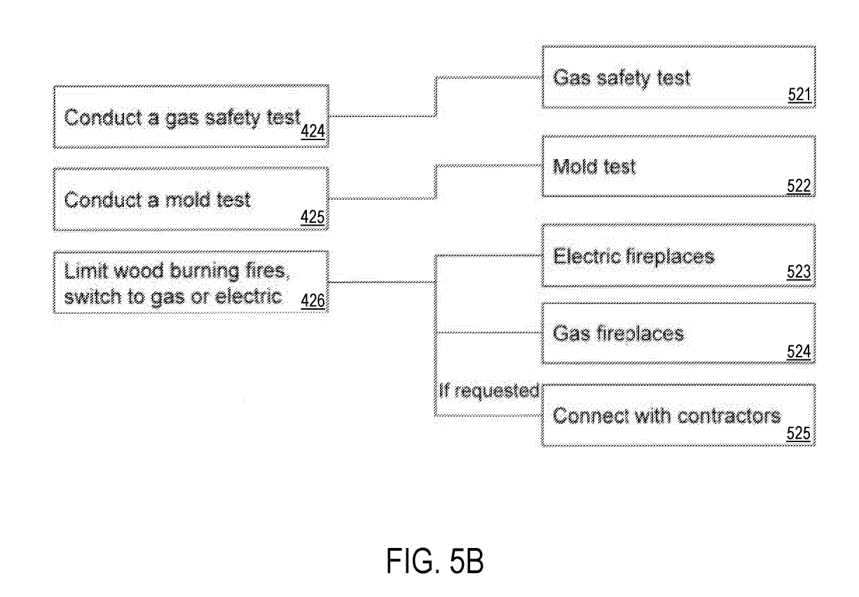

FIG. 5A illustrates an example process 420 implemented by the recommendation engine 130 involving a third set of rules, in one or more embodiments. In one embodiment, the recommendation engine 130 is configured to receive at least one of the following: (1) monitoring data 421 comprising one or more readings indicative of levels of toxins and pollutants at a property area (e.g., PM, VOCs, CO, etc.), (2) home profile data 422 comprising information relating to one or more gas appliances at the property area and/or a fireplace at the property area, and (3) third party data 423. In one embodiment, the recommendation engine 130 is configured to prioritize the third party data 423 based on age of the property area, outdoor pollutants, and/or weather (e.g., humidity).

If the monitoring data 421 indicates high levels of toxins and pollutants at the property area (e.g., high levels of humidity, PM2.5, VOCs, CO, etc.), the recommendation engine 130 is configured to generate a recommendation based on the home profile data 422 and/or the third party data 423.

For example, if the recommendation engine 130 determines that the property area has one or more gas appliances and/or a gas fireplace, the recommendation engine 130 generates a recommendation 424 to conduct a combustion/gas safety test (e.g., a combustion appliance safety test).

For example, if the recommendation engine 130 determines that the property area is old, has high humidity, has particulates, and that no tests were conducted, the recommendation engine 130 generates a recommendation 425 to conduct a mold test.

For example, if the recommendation engine 130 determines that the property area has a wood fireplace, the recommendation engine 130 generates a recommendation 426 to limit wood burning fires and/or switch the wood fireplace to a gas fireplace or an electric fireplace.

If the monitoring data 421 indicates low or moderate levels of toxins and pollutants at the property area instead (e.g., low or moderate levels of humidity, PM2.5, VOCs, CO, etc.), the recommendation engine 130 is configured to generate a recommendation 427 to open windows and doors (e.g., to improve airflow at the property area).

FIG. 5B illustrates specific recommendations generated by the recommendation engine 130 as part of the example process 420 in FIG. 5A, in one or more embodiments. Based on the monitoring data 421, the home profile data 422, and/or the third party data 423, the recommendation engine 130 is configured to generate recommendations with specific details.

For example, with respect to the recommendation 424, the recommendation engine 130 may provide an online service 521 that allows a user to schedule a gas safety test at the property area and/or purchase the gas safety test.

For example, with respect to the recommendation 425, the recommendation engine 130 may provide an online service 522 that allows a user to schedule a mold test at the property area and/or purchase the mold test.

For example, with respect to the recommendation 426, the recommendation engine 130 may include information indicative of a type of fireplace to install. The recommendation engine 130 generates either a specific recommendation 523 to install an electric fireplace or a specific recommendation 524 to install a gas fireplace.

In one embodiment, the recommendation engine 130 receives a request from a user to connect with service providers that can provide contractors/installers to perform the recommended installation of a fireplace (e.g., an electric fireplace or a gas fireplace). In response to receiving the request from the user, the recommendation engine 130 provides one or more online tools 525 that allow the user to connect with one or more service providers to schedule a service appointment for the installation, obtain quotes for the installation, pre-pay for the installation, etc.

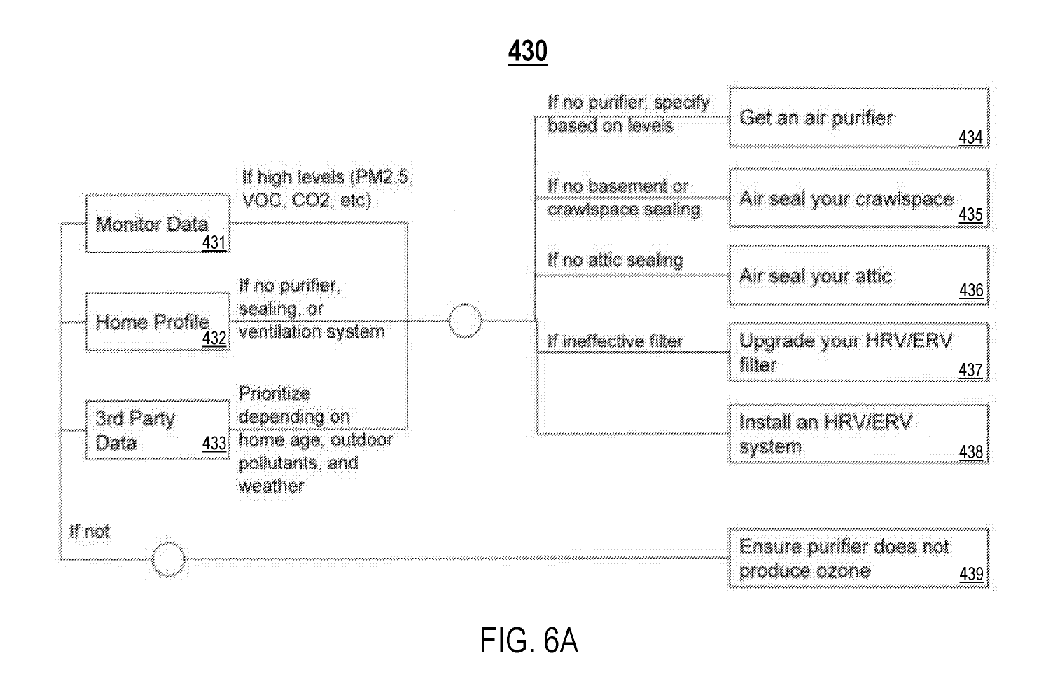

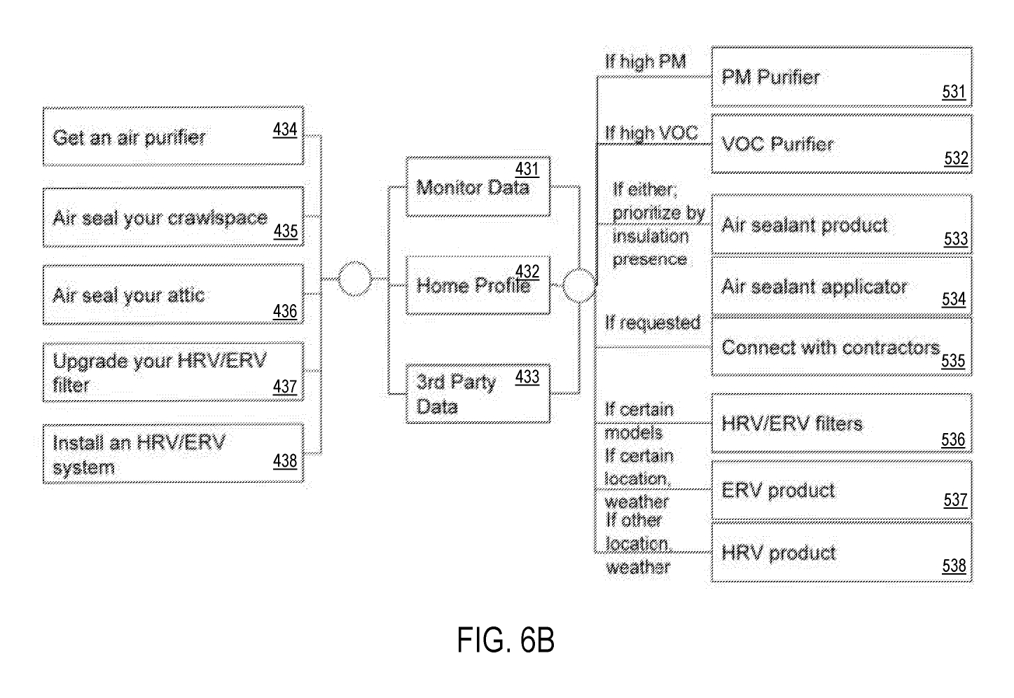

FIG. 6A illustrates an example process 430 implemented by the recommendation engine 130 involving a fourth set of rules, in one or more embodiments. In one embodiment, the recommendation engine 130 is configured to receive at least one of the following: (1) monitoring data 431 comprising one or more readings indicative of levels of toxins and pollutants at a property area (e.g., PM, VOCs, CO2, etc.), (2) home profile data 432 comprising information relating to a purifier at the property area, sealing of one or more structures (e.g., crawlspace, basement, attic) at the property area, and/or a ventilation system, such as a heat recovery ventilation (HRV) or an energy recovery ventilation system (ERV), at the property area, and (3) third party data 433. In one embodiment, the recommendation engine 130 is configured to prioritize the third party data 433 based on age of the property area, outdoor pollutants, and/or weather.

If the monitoring data 431 indicates high levels of toxins and pollutants at the property area (e.g., high levels of PM2.5, VOCs, CO2 etc.), the recommendation engine 130 is configured to generate a recommendation based on the home profile data 432 and/or the third party data 433.

For example, if the recommendation engine 130 determines that the property area does not have a purifier, the recommendation engine 130 generates a recommendation 434 to get an air purifier. As described in detail later herein, in one embodiment, the recommendation 434 includes information indicative of a type of air purifier to get based on levels of toxins and pollutants at the property area (as determined from the monitoring data 431).

For example, if the recommendation engine 130 determines that the property area has a crawlspace or a basement without sealing, the recommendation engine 130 generates a recommendation 435 to air seal the crawlspace or basement. As another example, if the recommendation engine 130 determines that the property area has an attic without sealing, the recommendation engine 130 generates a recommendation 436 to air seal the attic.

For example, if the recommendation engine 130 determines that the property area has an ineffective filter, the recommendation engine 130 generates a recommendation 437 to upgrade a filter at the property area (e.g., upgrade a HRV/ERV filter) or a recommendation 438 to install a ventilation system at the property area (e.g., install an HRV/ERV system).

If the monitoring data 431 indicates low or moderate levels of toxins and pollutants at the property area (e.g., low or moderate levels of PM2.5, VOCs, CO2, etc.), the recommendation engine 130 generates a recommendation 439 to monitor a purifier at the property area to ensure that it does not produce ozone.

FIG. 6B illustrates specific recommendations generated by the recommendation engine 130 as part of the example process 430 in FIG. 6A, in one or more embodiments. Based on the monitoring data 431, the home profile data 432, and/or the third party data 433, the recommendation engine 130 is configured to generate recommendations with specific details.

In one embodiment, with respect to the recommendation 434, the recommendation engine 130 includes information indicative of a type of air purifier to get based on levels of toxins and pollutants at the property area (as determined from the monitoring data 431). Specifically, if levels of PM at the property area is high, the recommendation engine 130 generates a specific recommendation 531 to add a PM purifier to the property area. If levels of a VOC at the property area is high, the recommendation engine 130 generates a specific recommendation 532 to add a VOC purifier to the property area.

In one embodiment, with respect to the recommendations 435 and/or 436, the recommendation engine 130 includes information indicative of a type of air sealant product and/or air sealant applicator to air seal with (e.g., suitable for sealing a crawl space/basement and/or an attic of the property area). For example, the recommendation engine 130 prioritizes different available air sealant products based on presence of insulation at the property area (as determined from the home profile data 432), and generates a specific recommendation 533 to air seal with a particular air sealant product having a highest priority. As another example, the recommendation engine 130 prioritizes different available air sealant applicators based on presence of insulation at the property area (as determined from the home profile data 432), and generates a specific recommendation 534 to air seal with a particular air sealant applicator having a highest priority.

In one embodiment, the recommendation engine 130 receives a request from a user to connect with service providers that can provide contractors/installers to perform a recommended air sealing of a crawlspace/basement or an attic at the property area. In response to receiving the request from the user, the recommendation engine 130 provides one or more online tools 535 that allow the user to view one or more available service providers, schedule a service appointment for the recommended air sealing with an available service provider, obtain quotes for the recommended air sealing from an available service provider, pre-pay for the recommended air sealing, etc.

In one embodiment, with respect to the recommendation 437, the recommendation engine 130 includes information indicative of a type of filter to upgrade to. For example, if the recommendation engine 130 determines that the property area has a ventilation system of a particular model (as determined from the home profile data 432), the recommendation engine 130 generates a specific recommendation 536 to upgrade to the filter to a particular type of filter (e.g., a HRV/ERV filter) suitable for the model.

In one embodiment, with respect to the recommendation 438, the recommendation engine 130 includes information indicative of a type of ventilation system to install (e.g., suitable for a location of the property area). For example, if the recommendation engine 130 determines that the property area is located at a particular location with a particular set of weather conditions (as determined from the home profile data 432 and/or the third party data 433), the recommendation engine 130 generates a specific recommendation 537 to install an ERV product suitable for the particular set of weather conditions. As another example, if the recommendation engine 130 determines that the property area is located at another location with another set of weather conditions (as determined from the home profile data 432 and/or the third party data 433), the recommendation engine 130 generates a specific recommendation 538 to install an HRV product suitable for the another set of weather conditions.

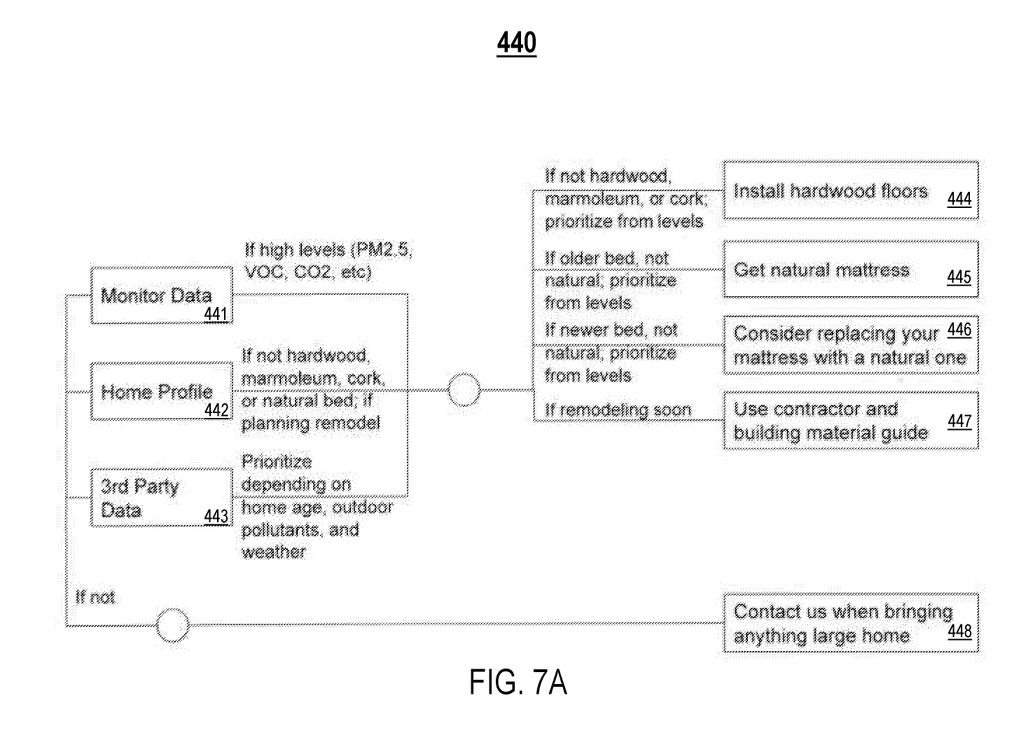

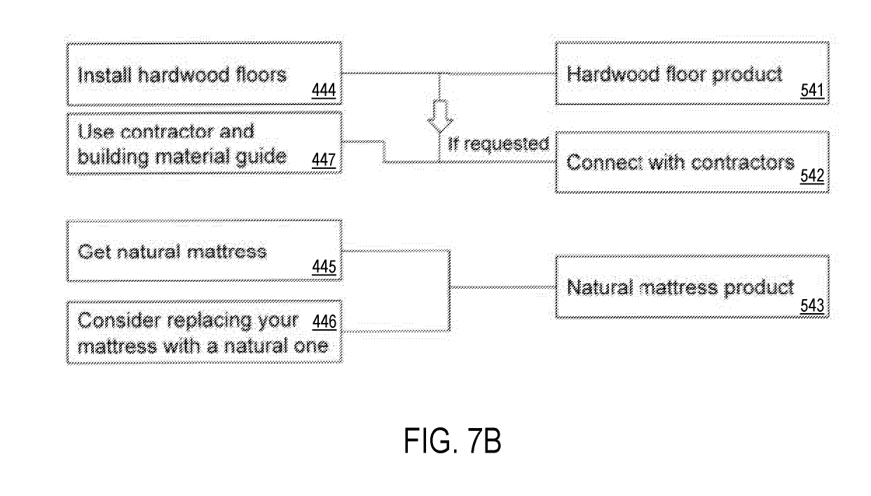

FIG. 7A illustrates an example process 440 implemented by the recommendation engine 130 involving a fifth set of rules, in one or more embodiments. In one embodiment, the recommendation engine 130 is configured to receive at least one of the following: (1) monitoring data 441 comprising one or more readings indicative of levels of toxins and pollutants at a property area (e.g., PM, VOCs, etc.), (2) home profile data 442 comprising information relating to a flooring system at the property area, bedding at the property area, and/or whether the property area will be remodeled soon (e.g., a property owner is planning a remodel of the property area), and (3) third party data 443. In one embodiment, the recommendation engine 130 is configured to prioritize the third party data 443 based on age of the property area, outdoor pollutants, and/or weather.

If the monitoring data 441 indicates high levels of toxins and pollutants at the property area (e.g., high levels of PM2.5, VOCs, CO2, etc.), the recommendation engine 130 is configured to generate a recommendation based on the home profile data 442 and/or the third party data 443.

For example, if the recommendation engine 130 determines that a flooring system at the property area is not hardwood, marmoleum, or cork, the recommendation engine 130 generates a recommendation 444 to install hardwood floors at the property area. As described in detail later herein, in one embodiment, the recommendation engine 130 determines and recommends a particular hardwood floor product suitable for the property area by prioritizing different available hardwood floor products based on the levels of toxins and pollutants at the property area.

For example, if the recommendation engine 130 determines that a bed at the property area is old and includes a mattress that is not natural, the recommendation engine 130 generates a recommendation 445 to get a natural mattress. As another example, if the recommendation engine 130 determines that a bed at the property area is new/newer and includes a mattress that is not natural, the recommendation engine 130 generates a recommendation 446 to consider replacing the existing mattress with a natural mattress.

For example, if the recommendation engine 130 determines that the property area will be remodeled soon, the recommendation engine 130 generates a recommendation 447 to use a contractor and/or a building material guide for the remodeling. The building material guide is indicative of building materials suitable for the property area.

If the monitoring data 441 indicates low or moderate levels of toxins and pollutants at the property area instead (e.g., moderate or low levels of PM2.5, VOCs, CO2, etc.), the recommendation engine 130 generates a recommendation 448 to contact/utilize the environmental analysis service at a later time, such as when the user brings anything large home.

FIG. 7B illustrates specific recommendations generated by the recommendation engine 130 as part of the example process 440 in FIG. 7A, in one or more embodiments. Based on the monitoring data 441, the home profile data 442, and/or the third party data 443, the recommendation engine 130 is configured to generate recommendations with specific details.

In one embodiment, with respect to the recommendation 444, the recommendation engine 130 includes information indicative of a particular hardwood floor product suitable for the property area. For example, the recommendation engine 130 generates a specific recommendation 541 to install a particular hardwood floor product at the property area.

In one embodiment, the recommendation engine 130 receives a request from a user to connect with service providers that can provide contractors/installers to perform the recommended installation of hardwood floors at the property area. In response to receiving the request from the user, the recommendation engine 130 provides one or more online tools 542 that allow the user to connect with one or more service providers to schedule a service appointment for the installation, obtain quotes for the installation, pre-pay for the installation, etc.

In one embodiment, with respect to the recommendation 447, the recommendation engine 130 provides the one or more online tools 542.

In one embodiment, with respect to the recommendations 445 and/or 446, the recommendation engine 130 includes information indicative of a type of natural mattress to get. For example, the recommendation engine 130 generates a specific recommendation 543 to get a particular natural mattress product.

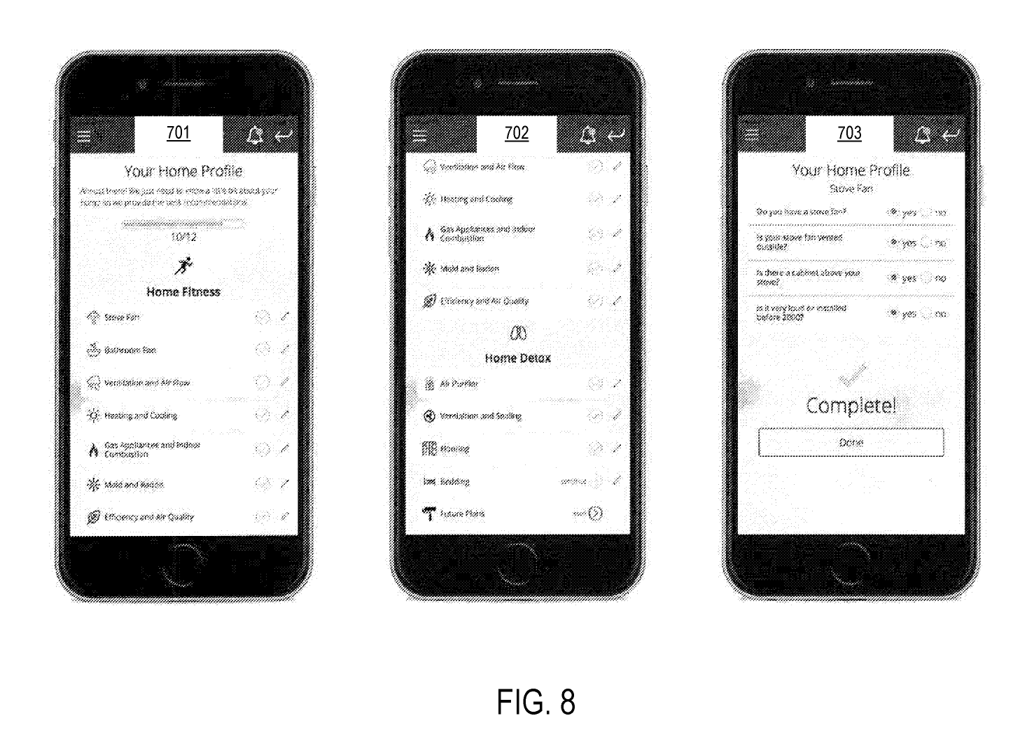

FIG. 8 illustrates a first set of example GUIs 701-703 generated by the recommendation engine 130 for display on a client device 300, in one or more embodiments. The GUIs 701-703 include a home profile questionnaire comprising questions related to a property area. As shown in FIG. 8, the questionnaire includes, but is not limited to, one or more sets of questions relating to the following: stove fan, bathroom fan, ventilation and air flow, gas appliances and indoor combustion, mold and radon, efficiency and air quality, air purifier, ventilation and sealing, flooring, bedding, future plans, etc. In one embodiment, the questionnaire is divided into different sections, and each set of questions of the questionnaire is organized into a particular section of the questionnaire (e.g., a set of questions relating to stove fan are included in a “Home Fitness” section, a set of questions relating to air purifier are included in a “Home Detox” section, etc.).

A user may interact with each GUI 701-703 (e.g., via an I/O unit 330 of the client device 300) to provide user responses to the questions. The recommendation engine 130 is configured to receive the user responses from the client device 300, and generate a home profile including home profile data for the property area based on the user responses.

In one embodiment, the questionnaire includes a GUI component indicative of a progress of the user in completing the questionnaire.

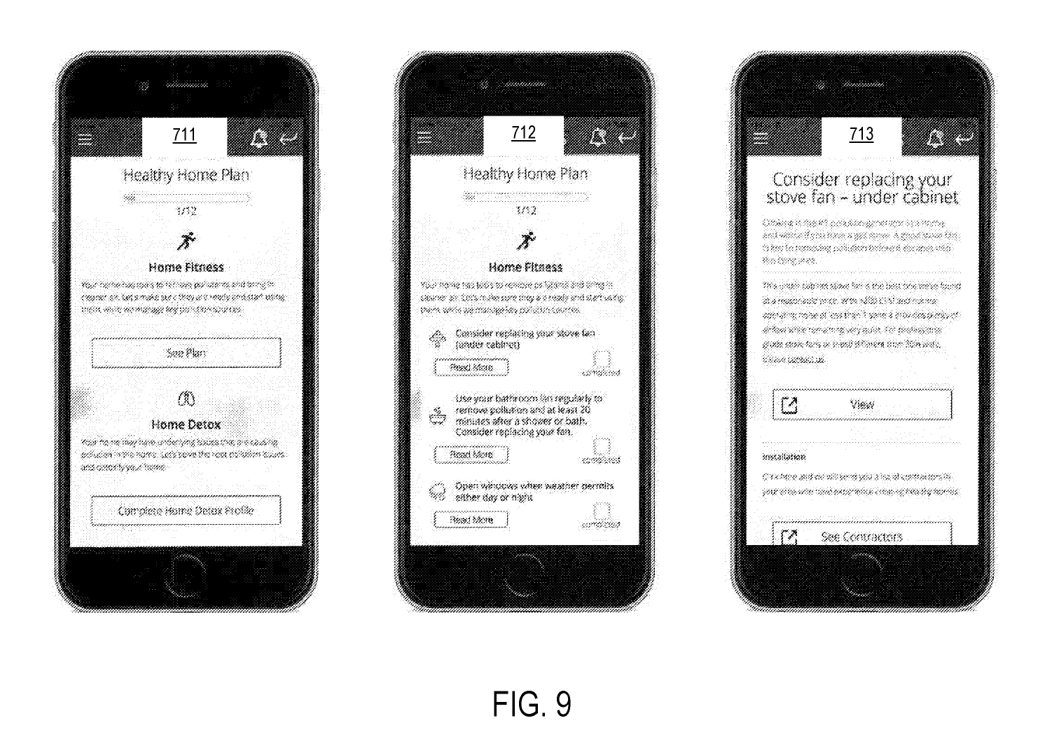

FIG. 9 illustrates a second set of example GUIs 711-713 generated by the recommendation engine 130 for display on a client device 300, in one or more embodiments. The GUIs 711-713 include a home plan for a property area, wherein the home plan comprises one or more recommendations generated by the recommendation engine 130 for improving an environment of the property area. As shown in FIG. 9, the one or more recommendations include a recommendation to replace a stove fan at the property area with an under cabinet stove fan. The recommendation may include specific details, such as properties that the under cabinet stove fan should have, contractors/installers available for installing the under cabinet stove fan, etc.

A user may interact with each GUI 711-713 (e.g., via an I/O unit 330 of the client device 300).

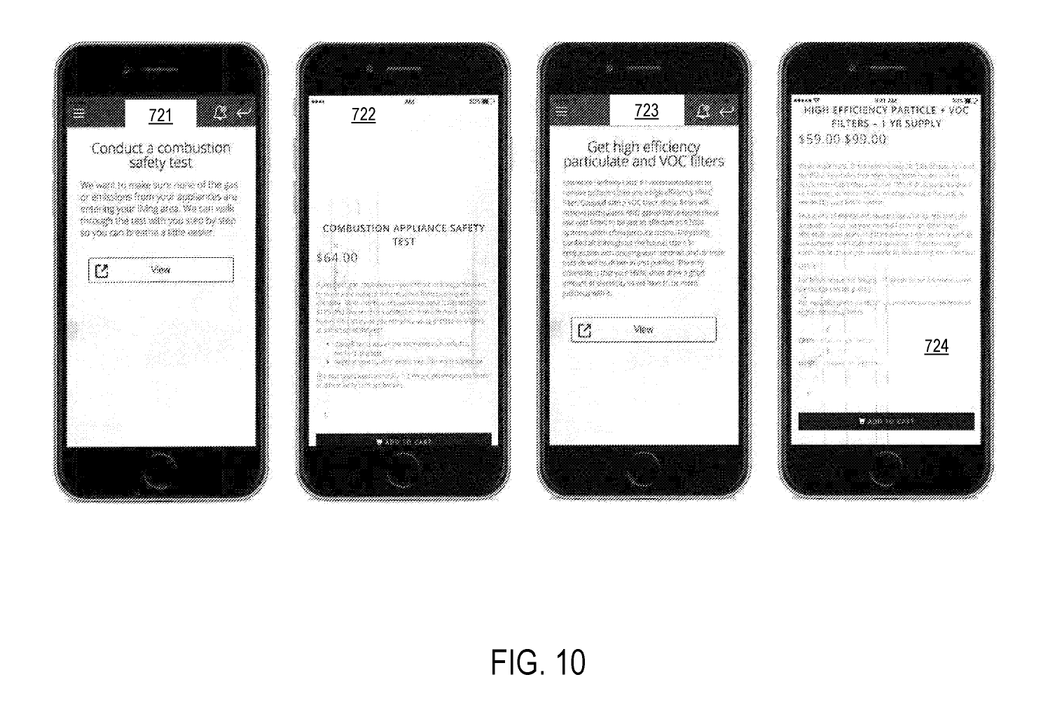

FIG. 10 illustrates a third set of example GUIs 721-724 generated by the recommendation engine 130 for display on a client device 300, in one or more embodiments. The GUIs 721-724 include one or more recommended services and/or products for improving an environment of a property area. As shown in FIG. 10, the one or more recommended services and/or products include, but are not limited to, a tool to purchase a recommended service (e.g., a combustion safety test, a mold test, etc.), a tool to purchase a recommended product (e.g., high efficiency particulate and VOC filters, etc.).

A user may interact with each GUI 721-724 (e.g., via an I/O unit 330 of the client device 300).

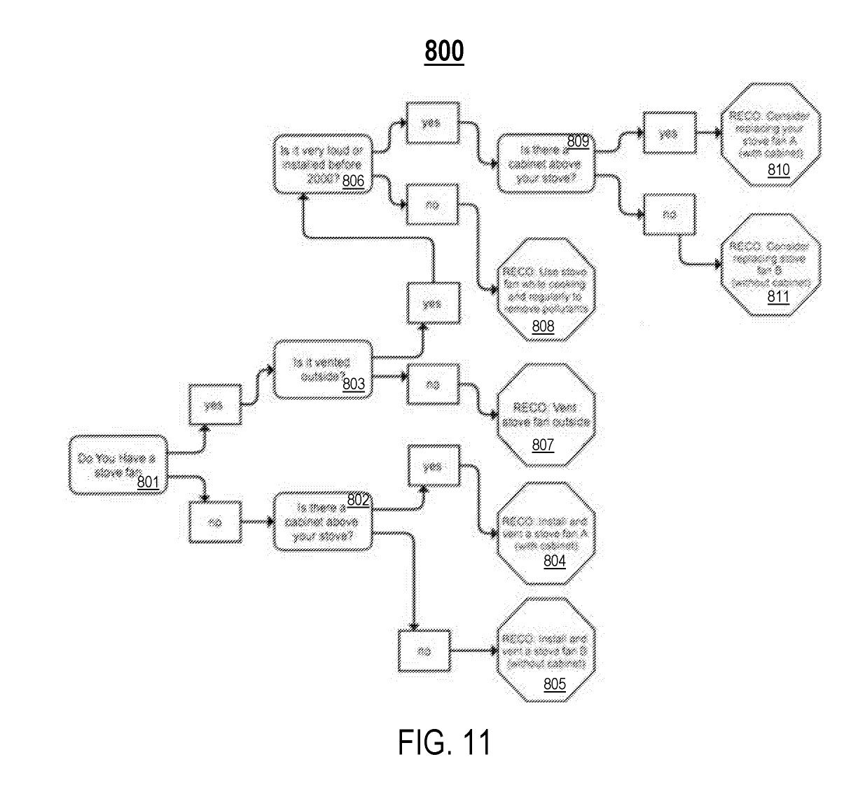

FIG. 11 is a flowchart of an example process 800 for generating a recommendation, in one or more embodiments. In process block 801, determine if a property area has a stove fan (e.g., based on home profile data for the property area). If the property area has no stove fan, proceed to process block 802. If the property area has a stove fan, proceed to process block 803.

In process block 802, determine if the property area has a cabinet above a stove. If the property area has a cabinet above a stove, proceed to process block 804 where a recommendation to install and vent a stove fan A (e.g., an under cabinet stove fan) is generated. If the property area does not have a cabinet above a stove, proceed to process block 805 where a recommendation to install and vent a stove fan B (e.g., a chimney fan) is generated.

In process block 803, determine if the stove fan is vented outside. If the stove fan is vented outside, proceed to process block 806. If the stove fan is not vented outside, proceed to process block 807 where a recommendation to vent the stove fan outside is generated.

In process block 806, determine if the stove fan is very loud or installed prior to a particular date (e.g., before 2000). If the stove fan is very loud or installed prior to a particular date (e.g., before 2000), proceed to process block 809. If the stove fan is neither very loud nor installed prior to a particular date (e.g., before 2000), proceed to process block 808 where a recommendation to use the stove fan while cooking and regularly to remove pollutants is generated.

In process block 809, determine if the property area has a cabinet above a stove. If the property area has a cabinet above a stove, proceed to process block 810 where a recommendation to install and vent a stove fan A (e.g., an under cabinet stove fan) is generated. If the property area has no cabinet above a stove, proceed to process block 811 where a recommendation to install and vent a stove fan B (e.g., a chimney fan) is generated.

In one embodiment, process blocks 801-811 may be performed by one or more components of the system 100, such as, but not limited to, the recommendation engine 130.

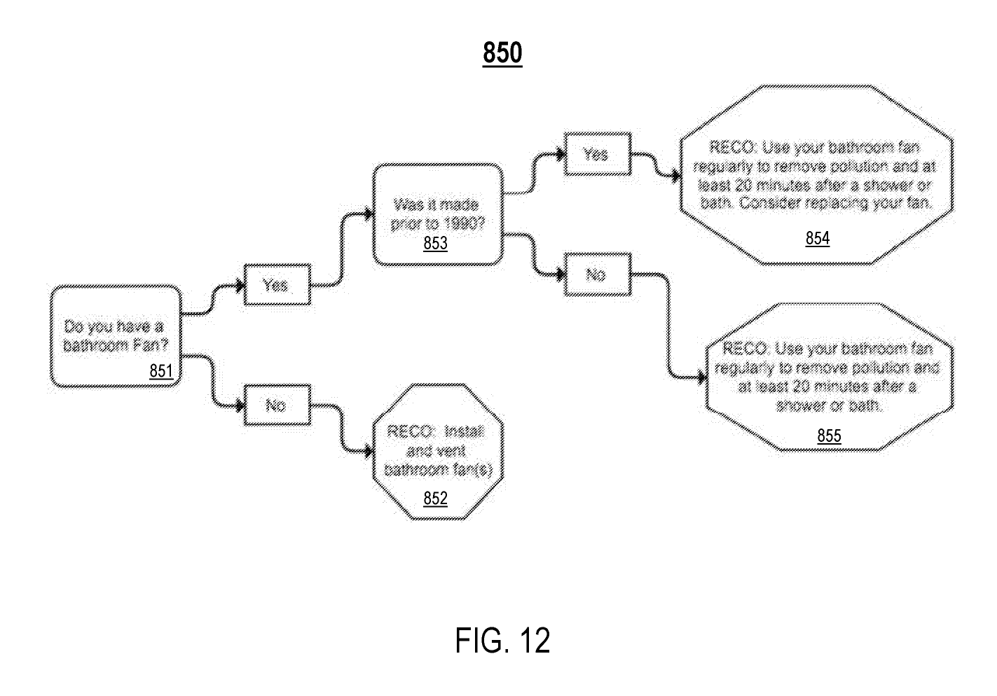

FIG. 12 is a flowchart of an example process 850 for generating a recommendation, in one or more embodiments. In process block 851, determine if a property area has a bathroom fan (e.g., based on home profile data for the property area). If the property area has no bathroom fan, proceed to process block 852 where a recommendation to install and vent one or more bathroom fans is generated. If the property area has a bathroom fan, proceed to process block 853.

In process block 853, determine if the bathroom fan was manufactured prior to a particular date (e.g., 1990). If the bathroom fan was manufactured prior to a particular date, proceed to process block 854 where a recommendation to use the bathroom fan regularly to remove pollution and for a particular duration (e.g., at least 20 minutes) after a shower or bath and/or to replace the bathroom fan is generated.

If the bathroom fan was not manufactured prior to a particular date, proceed to process block 855 where a recommendation to use the bathroom fan regularly to remove pollution and for a particular duration (e.g., at least 20 minutes) after a shower or bath is generated.

In one embodiment, process blocks 851-855 may be performed by one or more components of the system 100, such as, but not limited to, the recommendation engine 130.

TABLE 1 below provides an example home profile questionnaire, in one or more embodiments.

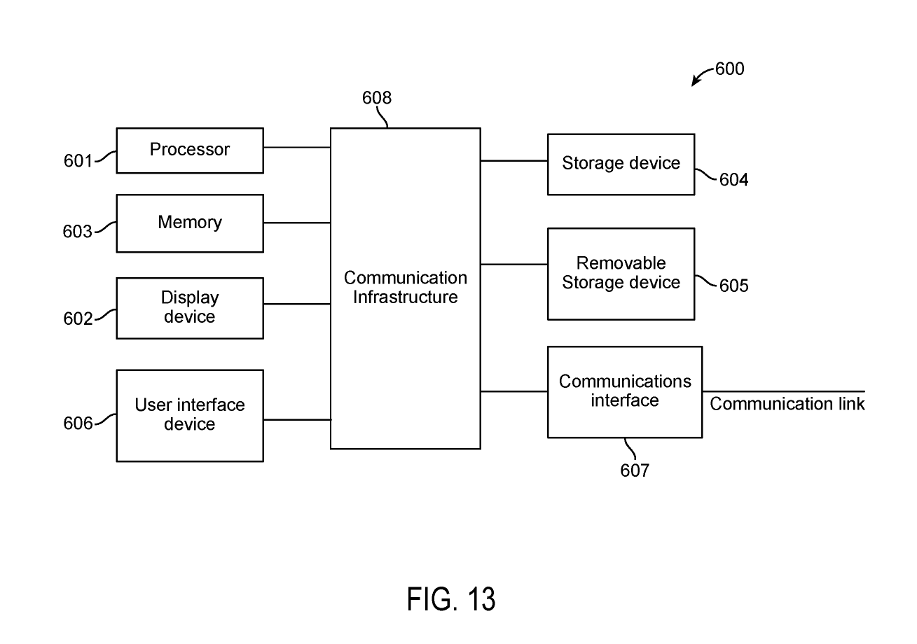

FIG. 13 is a high-level block diagram showing an information processing system comprising a computer system 600 useful for implementing the disclosed embodiments. Computer system 600 may be incorporated in an electronic device 100 or a server device (e.g., a server 200). The computer system 600 includes one or more processors 601, and can further include an electronic display device 602 (for displaying video, graphics, text, and other data), a main memory 603 (e.g., random access memory (RAM)), storage device 604 (e.g., hard disk drive), removable storage device 605 (e.g., removable storage drive, removable memory module, a magnetic tape drive, optical disk drive, computer readable medium having stored therein computer software and/or data), viewer interface device 606 (e.g., keyboard, touch screen, keypad, pointing device), a communication interface 607 (e.g., modem, a network interface (such as an Ethernet card), a communications port, or a PCMCIA slot and card), and a camera 609. The communication interface 607 allows software and data to be transferred between the computer system and external devices. The system 600 further includes a communications infrastructure 608 (e.g., a communications bus, cross-over bar, or network) to which the aforementioned devices/modules 601 through 607 are connected.

Information transferred via communications interface 607 may be in the form of signals such as electronic, electromagnetic, optical, or other signals capable of being received by communications interface 607, via a communication link that carries signals and may be implemented using wire or cable, fiber optics, a phone line, a cellular phone link, an radio frequency (RF) link, and/or other communication channels. Computer program instructions representing the block diagram and/or flowcharts herein may be loaded onto a computer, programmable data processing apparatus, or processing devices to cause a series of operations performed thereon to generate a computer implemented process. In one embodiment, processing instructions for process 800 (FIG. 11) and process 850 (FIG. 12) may be stored as program instructions on the memory 603, storage device 604 and the removable storage device 605 for execution by the processor 601.

Embodiments have been described with reference to flowchart illustrations and/or block diagrams of methods, apparatus (systems) and computer program products. Each block of such illustrations/diagrams, or combinations thereof, can be implemented by computer program instructions. The computer program instructions when provided to a processor produce a machine, such that the instructions, which execute via the processor create means for implementing the functions/operations specified in the flowchart and/or block diagram. Each block in the flowchart/block diagrams may represent a hardware and/or software module or logic. In alternative implementations, the functions noted in the blocks may occur out of the order noted in the figures, concurrently, etc.

The terms “computer program medium,” “computer usable medium,” “computer readable medium”, and “computer program product,” are used to generally refer to media such as main memory, secondary memory, removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

As will be appreciated by one skilled in the art, aspects of the embodiments may be embodied as a system, method or computer program product. Accordingly, aspects of the embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the embodiments may take the form of a computer program product embodied in one or more computer readable medium(s) having computer readable program code embodied thereon.

Any combination of one or more computer readable medium(s) may be utilized. The computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations for aspects of one or more embodiments may be written in any combination of one or more programming languages, including a product oriented programming language such as Java, Smalltalk, C++ or the like and conventional procedural programming languages, such as the “C” programming language or similar programming languages. The program code may execute entirely on the viewer's computer, partly on the viewer's computer, as a stand-alone software package, partly on the viewer's computer and partly on a remote computer or entirely on the remote computer or server. In the latter scenario, the remote computer may be connected to the viewer's computer through any type of network, including a local area network (LAN) or a wide area network (WAN), or the connection may be made to an external computer (for example, through the Internet using an Internet Service Provider).

Aspects of one or more embodiments are described above with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the embodiments has been presented for purposes of illustration and description, but is not intended to be exhaustive or limited to the embodiments in the form disclosed. Many modifications and variations will be apparent to those of ordinary skill in the art without departing from the scope and spirit of the invention.

Though the embodiments have been described with reference to certain versions thereof; however, other versions are possible. Therefore, the spirit and scope of the appended claims should not be limited to the description of the preferred versions contained herein.

What is claimed is:

1. A system comprising:
a data store maintaining an electronic record comprising a profile for a property area and environmental conditions for property area; and
a recommendation engine configured to:
access the electronic record in the data store;
automatically generate one or more recommendations to improve an environment of the property area based on a set of rules, the profile for the property area, and the environmental conditions for the property area; and
provide the one or more recommendations to a client device for display in an interactive graphical user interface on the client device.
